(19) United States
(12) Patent Application Publication
(10) Pub. No.: US 2026/0222974 A1
(43) Pub. Date: Jul. 30, 2026

(54) AUTOMATION SUB-SYSTEM CONNECTIVITY MANAGEMENT IN A STANDALONE CELLULAR NETWORK

(71) Applicant: DISH Wireless L.L.C., Englewood, CO (US)

(72) Inventors: Hrushikesh Shrikant Nanal, Littleton, CO (US); Madhuri Muttreja, Parker, CO (US); Scott Kitchens, Colorado Springs, CO (US)

(21) Appl. No.: 19/040,141

(22) Filed: Jan. 29, 2025

(51) Int. Cl. H04W 48/16; H04W 4/029

(52) U.S. Cl. CPC H04W 48/16; H04W 4/029

(57) ABSTRACT

Technologies for enabling communication via a current generation (e.g., fifth generation) standalone (SA) cellular network between a control system located at a first location and an automation sub-system including one or more controllable automation devices located at a second location. Access to the current generation SA cellular network by the automation sub-system is provided by a network interface device. Advantageously, the network interface device is coupled to the automation sub-system at the second location to enable data communications between the one or more controllable automation devices and a base station providing access to the current generation standalone cellular network.

### BACKGROUND

Enterprises often maintain multiple different automation sub-systems distributed across large industrial facilities. These automation sub-systems typically include a number of controllable automation devices (e.g. programmable logic controllers (PLCs), human machine interfaces (HMIs), sensing equipment, dispensing equipment, flow meters, etc.) having hardware and software that is controlled by a de-centralized control system communicatively coupled via a network connection. Typically, the control system is coupled to the one or more automation sub-systems using a traditional router device and a wired broadband connection, which has a geographically limited coverage area (e.g., a typical maximum area of coverage of less than one mile).

To address this network-based limitation associated with managing automation devices, large industrial facilities may deploy additional Ethernet router devices. However, the addition of these devices leads to constraints on the network connectivity associated with the controllable automation devices of the one or more automation sub-systems. Furthermore, the constrained bandwidth speed may not meet the requirements associated with controlling the controllable automation devices, resulting in reduced productivity.

### BRIEF DESCRIPTION OF THE DRAWINGS

The present disclosure is illustrated by way of example, and not by way of limitation, in the figures of the accompanying drawings.

FIG. 1 is a block diagram of a system implementing high-speed connectivity for distributed control of automation sub-systems via a current generation standalone (SA) cellular network, according to one or more embodiments.

FIG. 2 is a block diagram of a system including a current generation standalone (SA) cellular network providing connectivity between a control system and an automation sub-system, according to one or more embodiments.

FIG. 3 is a block diagram of the service catalog with an example common data processing engine according to at least one embodiment.

FIG. 4 is a block diagram of a data management platform with a service catalog being deployed in a region of a current generation standalone cellular network according to at least one embodiment.

FIG. 5 is a block diagram of a data management platform with a data catalog being deployed in a region of a current generation standalone cellular network according to at least one embodiment.

FIG. 6 is a flow diagram of example method of implementing access control of an automation sub-system in a current generation standalone cellular network according to at least one embodiment.

FIG. 7 is a block diagram of an example computer system in which embodiments of the present disclosure can operate.

### DETAILED DESCRIPTION

Technologies for implementing high-speed connectivity for distributed control of automation sub-systems via a current generation standalone (SA) cellular network (e.g., a 5G SA cellular network, a 6G SA cellular network, etc.) are described. The following description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or presented in simple block diagram format to avoid obscuring the present disclosure unnecessarily. Thus, the specific details set forth are merely exemplary. Particular implementations may vary from these exemplary details and still be contemplated to be within the scope of the present disclosure.

An industrial enterprise may maintain and manage several physical locations (e.g., warehouses) including one or more automation sub-systems including controllable automation devices that are “remotely” controlled by a control system via a network. Traditionally, the network environment supporting these controllable automation devices include a Broadband Ethernet switch connected to an Ethernet switch using one or more Ethernet cables. Also included in this network environment is a single Ethernet wired cable connection from a local area network (LAN) port or wide area network (WAN)/LAN port of a router device. Disadvantageously, this traditional router and wired broadband connection significantly limits the coverage area associated with the network, thereby constraining the ability to use the network to effectively and efficiently manage the automation sub-systems.

Aspects and embodiments of the present disclosure address the above and other deficiencies by providing a system including a network interface device enabling access by one or more automation sub-systems to a current generation standalone (SA) network such as, for example, a 5G SA open radio access network (ORAN). According to embodiments, the network interface device is coupled to the automation sub-system including one or more controllable automation devices to enable connectivity the transmission of data communication between the one or more controllable automation devices and a base station providing access to the SA cellular network (also referred to herein as the “standalone cellular network” or “SA ORAN” or “current generation SA cellular network”). According to embodiments, the network interface device enables connectivity between the automation sub-system (e.g., a set of one or more controllable automation devices associated with an enterprise) and one or more controllable automation device control systems (also referred to as “control systems”) via the SA cellular network for the transmission of communications relating to control of the controllable automation devices by the one or more control systems (herein referred to as “automation control communications”).

According to embodiments, the system enables the one or more automation sub-systems to communication with one or more control systems via the SA cellular network. According to embodiments, the SA cellular network includes a current generation Standalone Core Network (e.g., a 5G SA core) responsible for managing and routing data traffic associated with the automation sub-systems, providing various network resources and services automation sub-systems, and supporting the core functionalities of a current generation network (e.g., a 5G network) to enable control of the automation sub-systems by one or more control systems. As used herein, the term “standalone” or “SA” indicating that this core network operates independently of any existing 4G long-term evolution (LTE) infrastructure.

According to embodiments, the one or more automation sub-systems at a location are provided with access to the SA cellular network via a network interface device. According to embodiments, the one or more controllable automation devices (e.g., controllable devices such as printers, sensors, laptops, gaming devices, transducers, programmable logic controllers (PLCs), human machine interfaces (HMMs)

According to embodiments, the SA cellular network can be used for connectivity between automation sub-systems and controllable automation device control systems to transmit automation control communications with enhanced Mobile Broadband (eMBB) slicing. According to embodiments, the automation control communications may be transmitted via one or more time frequency division duplex (FDD) bands (e.g., n70 FDD band, n66 FDD band, n71 FDD band, etc.) or time division duplex (TDD) bands of a network interface device providing access to the SA cellular network (e.g., n48 TDD band, n77 TDD band, etc.).

According to embodiments, the SA cellular network can be configured on behalf of an enterprise (e.g., an entity associated with one or more locations including automation sub-systems) to establish one or more private access points (APNs) for the controllable automation devices of the one or automation sub-systems within the SA cellular network. Advantageously, the private APNs can be enabled to establish private connections (e.g., machine-to-machine (M2M) connections within the SA cellular network that are isolated from public plans (e.g., Internet-based plans that rely on 5G network slicing).

According to embodiments, the SA cellular network provides a combination of control and user plane separation (CUPS) and multi-access edge computing (MEC), which allows compute and storage resources to be moved from a centralized cloud location to the “edge” of a network and closer to the one or more controllable automation devices of the one or more automation sub-systems, may enable low-latency applications with millisecond response times. A control plane may include a part of the SA cellular network that controls how data packets are forwarded or routed to enable control of the one or more controllable automation devices of the automation sub-system 101 (e.g., one or more data communications configured to control the operation and functionality of the controllable automation device(s)). The control plane may be responsible for populating routing tables or forwarding tables to enable data plane functions. A data plane (or forwarding plane) may include a part of the SA cellular network that forwards and routes data packets based on control plane logic. Control plane logic may also identify packets to be discarded and packets to which a high quality of service should apply.

Aspects and embodiments of the present disclosure can provide access to the SA cellular network via the network interface device for connectivity between one or more controllable automation devices of an automation sub-system (e.g., residing in a location of an enterprise) and a remote control system. Advantageously, providing access by the controllable automation devices to the SA cellular network (e.g., a 5G SA ORAN) improves the efficiency and reliability of distribution automation systems and greatly enhances productivity. Furthermore, the SA cellular network offers a dependable and streamlined solution for high-speed connectivity and control of controllable automation devices associated with enterprise users.

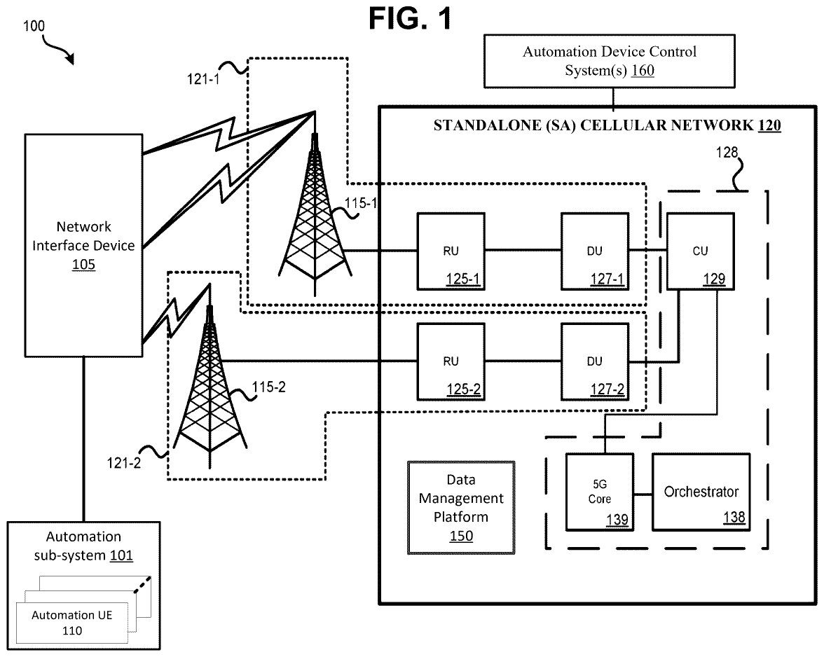

FIG. 1 illustrates an example cellular network system 100 (“system 100”) enabling connectivity by an automation sub-system 101 to a standalone (SA) cellular network 120, according to one or more embodiments. FIG. 1 represents an embodiment of a cellular network system 100 which can accommodate the cloud-based architecture. The cellular network system 100 can include the SA cellular network 120 (e.g., a current generation SA cellular network such as a 5G SA cellular network, a 6G SA cellular network, etc.). In an embodiment, the SA cellular network 120 is a SA open radio access network (ORAN).

As shown in FIG. 1, the cellular network system 100 can include the automation sub-system 101 including one or more controllable automation devices 110; base station 121; cellular network 120; radio units 125 (“RUs 125”); distributed units 127 (“DUs 127”); centralized unit 129 (“CU 129”); 5G core 139, and orchestrator 138. FIG. 1 represents a component-level view. In an open radio access network (ORAN), because components can be implemented as specialized software executed on general-purpose hardware, except for components that need to receive and transmit radio frequency (RF), the functionality of the various components can be shifted among different servers. For at least some components, the hardware may be maintained by a separate cloud-service provider, to accommodate where the functionality of such components is needed.

Automation user equipment (UE) 110 can represent various types of controllable automation devices that are controllable by one or more controllable automation device control systems 160, such as distributed control system (DCS) devices, programmable logic controllers (PLCs), human machine interfaces (HMIs), cellular phones, smartphones, cellular modems, cellular-enabled computerized devices, sensor devices, gaming devices, access points (APs), any computerized device capable of communicating via a cellular network, etc. Generally, automation UE 110 can represent any type of device that has an incorporated interface for coupling with the network interface device 105. Examples can include sensor devices, Internet of Things (IoT) devices, manufacturing robots; unmanned aerial (or land-based) vehicles, network-connected vehicles, etc.

According to embodiments, the automation sub-system 101 communicatively couples with the network interface device 105 to communication with various base stations 121 of the SA cellular network 120. In FIG. 1, two base stations 121 are illustrated: base station 121-1 can include: structure 115-1, RU 125-1, and DU 127-1. Structure 115-1 may be any structure to which one or more antennas (not illustrated) of the base station are mounted. Structure 115-1 may be a dedicated cellular tower, a building, a water tower, or any other human-made or natural structure to which one or more antennas can reasonably be mounted to provide cellular coverage to a geographic area. Similarly, base station 121-2 can include: structure 115-2, RU 125-2, and DU 127-2.

Real-world implementations of system 100 can include many (e.g., thousands) of base stations (BSs) and many CUs and 5G core 139. Structures 115 can include one or more antennas that allow RUs 125 to communicate wirelessly with automation UEs 110. RUs 125 can represent an edge of cellular network 120 where data is transitioned to wireless communication. The radio access technology (RAT) used by RU 125 may be 5G New Radio (NR), or some other RAT. The remainder of cellular network 120 may be based on an exclusive 5G architecture, a hybrid 4G/5G architecture, a 4G architecture, or some other cellular network architecture. Base station 121 equipment may include an RU (e.g., RU 125-1) and a DU (e.g., DU 127-1).

One or more RUs, such as RU 125-1, may communicate with DU 127-1. As an example, at a possible cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of the spectrum, such as, for example, band 71. One or more DUs, such as DU 127-1, may communicate with CU 129. Collectively, an RU, DU, and CU create a gNodeB, which serves as the radio access network (RAN) of cellular network 120. CU 129 can communicate with 5G core 139. The specific architecture of cellular network 120 can vary by embodiment. Edge cloud server systems outside of cellular network 120 may communicate, either directly, via the Internet, or via some other network, with components of cellular network 120. For example, DU 127-1 may be able to communicate with an edge cloud server system without routing data through CU 129 or 5G core 139. Other DUs may or may not have this capability.

While FIG. 1 illustrates various components of SA cellular network 120, other embodiments of the SA cellular network 120 can vary the arrangement, communication paths, and specific components of SA cellular network 120. While RU 125 may include specialized radio access componentry to enable wireless communication with automation UE 110, other components of cellular network 120 may be implemented using either specialized hardware, specialized firmware, and/or specialized software executed on a general-purpose server system. In an SA ORAN arrangement, specialized software on general-purpose hardware may be used to perform the functions of components such as DU 127, CU 129, and 5G core 139. Functionality of such components can be co-located or located at disparate physical server systems. For example, certain components of 5G core 139 may be co-located with components of CU 129.

In a possible virtualized SA ORAN implementation, CU 129, 5G core 139, and/or orchestrator 138 can be implemented virtually as software being executed by general-purpose computing equipment, such as in a data center of a cloud-computing platform, as detailed herein. Therefore, depending on needs, the functionality of a CU, and/or 5G core may be implemented locally to each other and/or specific functions of any given component can be performed by physically separated server systems (e.g., at different server farms). For example, some functions of a CU may be located at a same server facility as where the DU is executed, while other functions are executed at a separate server system. In the illustrated embodiment of system 100A, cloud-based cellular network components 128 include CU 129, 5G core 139, and orchestrator 138. Such cloud-based cellular network components 128 may be executed as specialized software executed by underlying general-purpose computer servers. Cloud-based cellular network components 128 may be executed on a third-party cloud-based computing platform or a cloud-based computing platform operated by the same entity that operates the RAN. A cloud-based computing platform may have the ability to devote additional hardware resources to cloud-based cellular network components 128 or implement additional instances of such components when requested.

A container orchestration platform (e.g., Kubernetes) can be used to create and destroy the logical CU or 5G core units and subunits as needed for the cellular network 120 to function properly. Kubernetes allows for container deployment, scaling, and management. As an example, if cellular traffic increases substantially in a region, an additional logical CU or components of a CU may be deployed in a data center near where the traffic is occurring without any new hardware being deployed. (Rather, processing and storage capabilities of the data center would be devoted to the needed functions.) When the need for the logical CU or subcomponents of the CU no longer exists, Kubernetes can allow for removal of the logical CU. Kubernetes can also be used to control the flow of data (e.g., messages) and inject a flow of data to various components. This arrangement can allow for the modification of nominal behavior of various layers.

The deployment, scaling, and management of such virtualized components can be managed by orchestrator 138. Orchestrator 138 can represent various software processes executed by underlying computer hardware. Orchestrator 138 can monitor cellular network 120 and determine the amount and location at which cellular network functions should be deployed to meet or attempt to meet service level agreements (SLAs) across slices of the cellular network.

Orchestrator 138 can allow for the instantiation of new cloud-based components of cellular network 120. As an example, to instantiate a new core function, orchestrator 138 can perform a pipeline of calling the core function code from a software repository incorporated as part of, or separate from, cellular network 120; pulling corresponding configuration files (e.g., helm charts); creating Kubernetes nodes/pods; loading the related core function containers; configuring the core function; and activating other support functions (e.g., Prometheus, instances/connections to test tools).

A network slice functions as a virtual network operating on cellular network 120. Cellular network 120 is shared with some number of other network slices, such as hundreds or thousands of network slices. Communication bandwidth and computing resources of the underlying physical network can be reserved for individual network slices, thus allowing the individual network slices to reliably meet defined SLA parameters. By controlling the location and amount of computing and communication resources allocated to a network slice, the quality of service (QoS) and quality of experience (QoE) for automation UE can be varied on different slices. A network slice can be configured to provide sufficient resources for a particular application to be properly executed and delivered (e.g., gaming services, video services, voice services, location services, sensor reporting services, data services, etc.). However, resources are not infinite, so allocation of an excess of resources to a particular automation UE group and/or application may be desired to be avoided. Further, a cost may be attached to cellular slices: the greater the amount of resources dedicated, the greater the cost to the user; thus, optimization between performance and cost is desirable.

Particular network slices may only be reserved in particular geographic regions. For instance, a first set of network slices may be present at RU 125-1 and DU 127-1, a second set of network slices, which may only partially overlap or may be wholly different from the first set, may be reserved at RU 125-2 and DU 127-2.

Further, particular cellular network slices may include some number of defined layers. Each layer within a network slice may be used to define QoS parameters and other network configurations for particular types of data. For instance, high-priority data sent by a automation UE may be mapped to a layer having relatively higher QoS parameters and network configurations than lower-priority data sent by the automation UE that is mapped to a second layer having relatively less stringent QoS parameters and different network configurations.

Components such as DUs 127, CU 129, orchestrator 138, and 5G core 139 may include various software components that are required to communicate with each other, handle large volumes of data traffic, and are able to properly respond to changes in the network. In order to ensure not only the functionality and interoperability of such components, but also the ability to respond to changing network conditions and the ability to meet or perform above vendor specifications, significant testing must be performed.

5G core 139, which can be physically distributed across data centers or located at a central national data center (NDC), can perform various core functions of the cellular network. 5G core 139 can include: network resource management components; policy management components; subscriber management components; and packet control components. Individual components may communicate on a bus, thus allowing various components of 5G core 139 to communicate with each other directly. 5G core 139 is simplified to show some key components. Implementations can involve additional other components.

Network resource management components can include network repository function (NRF) and network slice selection function (NSSF). NRF can allow 5G network functions (NFs) to register and discover each other via a standards-based application programming interface (API). NSSF can be used by access and mobility management function (AMF) (e.g., AMF 234) to assist with the selection of a network slice that will serve a particular automation UE.

Policy management components can include charging function (CHF) and policy control function (PCF). CHF allows charging services to be offered to authorized network functions. Converged online and offline charging can be supported. PCF allows for policy control functions and the related 5G signaling interfaces to be supported.

Subscriber management components can include unified data management (UDM) and authentication server function (AUSF). UDM can allow for generation of authentication vectors, user identification handling, NF registration management, and retrieval of automation UE individual subscription data for slice selection. AUSF performs authentication with automation UE.

Packet control components can include access and mobility management function (AMF) and session management function (SMF). AMF can receive connection- and session-related information from automation UE and is responsible for handling connection and mobility management tasks. SMF is responsible for interacting with the decoupled data plane, creating, updating, and removing protocol data unit (PDU) sessions, and managing session context with the user plane function (UPF) (e.g., manage automation UE context and network handovers between base stations).

User plane function (UPF) can be responsible for packet routing and forwarding, packet inspection, QoS handling, and external PDU sessions for interconnecting with a data network (DN) (e.g., data network) (e.g., the Internet) or various access networks. Access networks can include the RAN of cellular network 120.

5G core 139 may reside on a cloud computing platform. While from a client's or user's point of view, the “cloud” can be envisioned as an ephemeral computing workspace that occupies no physical space, in reality, a cloud computing platform is an interconnected group of data centers throughout which computing and storage resources are spread. Therefore, data centers may be scattered geographically and can provide redundancy.

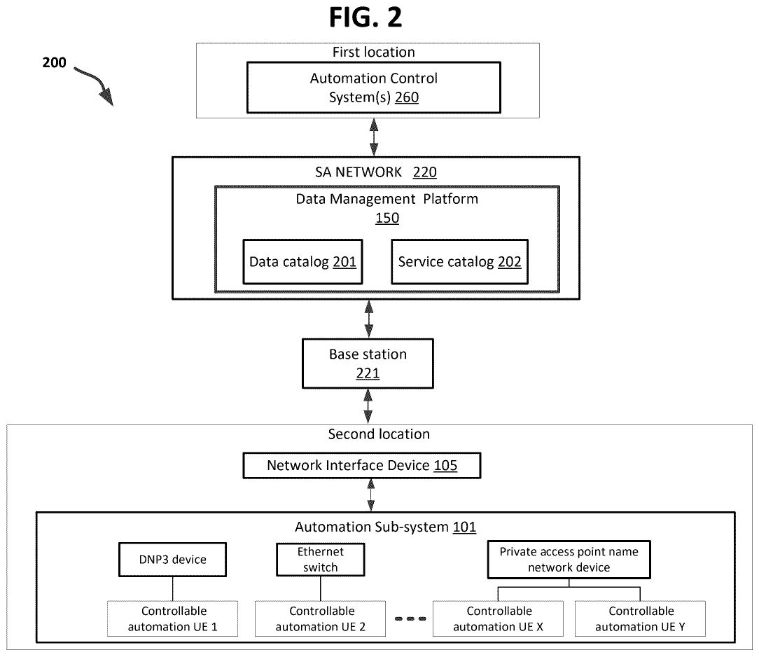

FIG. 2 illustrates an example cellular network system 200 (“system 200”) enabling connectivity between an automation sub-system 101 including one or more controllable automation UEs (e.g., controllable automation UE 1, controllable automation UE 2 . . . controllable automation UE X, and controllable automation UE Y) and one or more automation control systems 260 (control system(s) 260) via using a network interface device 105 coupled to a current generation SA network 220. According to embodiments, the SA network 220 includes one or more processing devices to enable transmission of one or more data communications (e.g., control-related communications) between the automation control system(s) 260 located at a first location and the automation sub-system 101 located at a second location.

According to embodiments, the network interface device 105 is coupled to the controllable automation UE of the automation sub-system 101. In an embodiment, the network interface device 105 is coupled to one or more of the controllable automation UEs via a distributed network protocol (DNP3) device. For example, the network interface device 105 may be coupled by one or more connections (e.g., one or more Ethernet cables) to the DNP3 protocol-based device, which is in turn coupled by one or more Ethernet connections to one or more PLCs. As illustrated in FIG. 2, the above-described connectivity path including the DNP3 device and the network interface device 105 enables the one or more PLCs (e.g., controllable automation UE 1 of FIG. 2) to couple to a base station 221 (e.g., a RAN or ORAN base station) for access to the SA network 220. Example DNP3 devices include remote terminal units (RTUs), intelligent electronic devices (IEDs), meters, relays, breakers, electronic vessel control (EVC) devices, etc.

In an embodiment, the network interface device 105 is coupled to one or more of the controllable automation UEs via an Ethernet switch. For example, the network interface device 105 may be coupled by one or more connections (e.g., one or more Ethernet cables) to the Ethernet switch device, which is in turn coupled by one or more connections (e.g., one or more Ethernet cables) to one or more controllable automation UEs (e.g., one or more HMIs, one or more compressor control systems, one or more serial connectors (e.g., RS-232 connectors, RS-422 connectors, RS-485 connectors) associated with one or more serial connection dispensers, etc.). As illustrated in FIG. 2, the above-described connectivity path including the Ethernet switch and the network interface device 105 enables the one or more controllable automation UEs (e.g., controllable automation UE 2 of FIG. 2) to couple to a base station 221 for access to the SA network 220.

In an embodiment, the network interface device 105 is coupled to a set of multiple controllable automation UEs (e.g., controllable automation UE X and controllable automation UE Y of FIG. 2) via private access point name network device. For example, the network interface device 105 may be coupled by one or more connections (e.g., one or more Ethernet cables) to the private access point name network device, which is in turn coupled by one or more connections (e.g., one or more Ethernet cables) to create a private access network for the multiple controllable automation UEs. According to embodiments, the private access point name network devices establish private connections (e.g., machine-to-machine (M2M) connections within the SA cellular network that are isolated from public plans (e.g., Internet-based plans that rely on 5G network slicing) and provide a virtual network (e.g., using eMBB slicing) to a set of multiple controllable automation UEs (e.g., controllable automation UE X and controllable automation UE Y of FIG. 2).

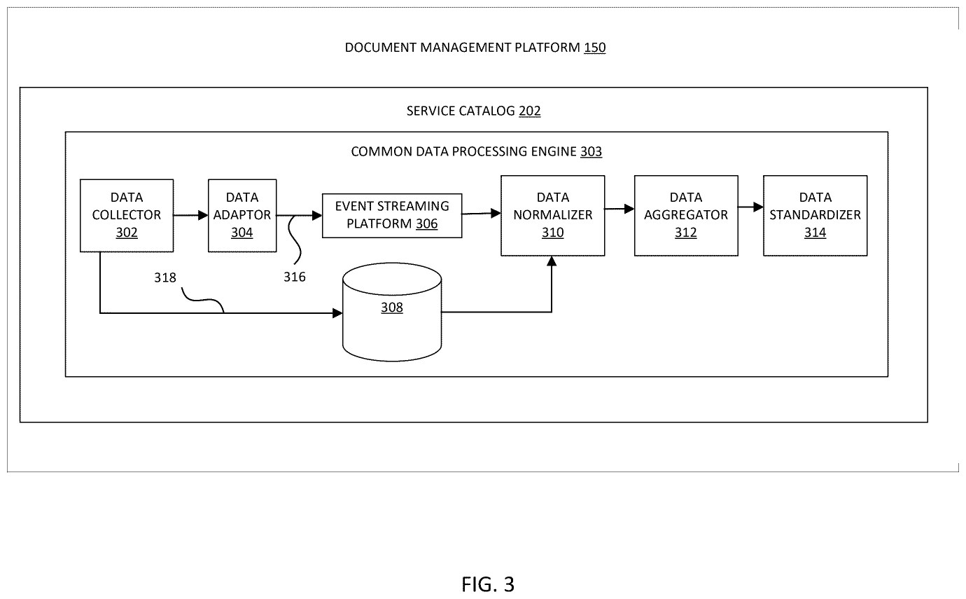

As illustrated in FIG. 2, the SA network 220 includes a data management platform 150. The data management platform 150 is a system or suite of tools and technologies designed to manage, store, process, analyze, and/or visualize large volumes of data associated with the controllable automation UEs of the automation sub-system 101 (e.g. data catalog 201). According to embodiments, the data catalog 201 can provide the singular comprehensive view of collected data. As described in more detail below, the data catalog can be used in connection with a service catalog 202. The service catalog 202 can store a common data processing engine (e.g., common data processing engine 303 of FIG. 3) that is configured to ingest, process, store, and deliver telemetry data from a data source in the cellular network to one or more object stores.

The data management platform 150 can be used by modern data-driven organizations, enabling them to harness the power of their data for various purposes, such as business intelligence, analytics, machine learning, and more. In general, the data management platform 150 includes components for data ingestion, data storage, data processing, data management, data integration, data analytics, machine learning (ML) and artificial intelligence (AI) platforms, data security, or the like. For example, a data ingestion component can use extract, transform, load (ETL) logic (tools or processes) that extract data from various sources, transform it into a suitable format, and load it into a storage system. The data ingestion component can be set up to stream real-time data from sources, such as Internet of Things (IoT) devices, transactional systems, or other network functions. The data management platform 150 can include data storage components, such as data lakes, data warehouses, database systems. Data lakes are large storage repositories that hold raw data in its native format until it is needed. Data warehouses is structured storage systems optimized for query performance and analytics, often storing cleaned and processed data. Database Systems can include both relational (e.g., SQL) and non-relational (e.g., NoSQL) databases for various data storage needs. The data processing components can handle batch processing, streaming processing, or the like. Batch processing can handle large volumes of data in batches, typically for tasks like reporting, data transformation, and aggregation. Stream processing can handle real-time processing of continuous data streams to support applications like real-time analytics and monitoring. Data management components can handle metadata management and data governance. The metadata management can include tools for managing metadata, which is data about data, including data catalogs, lineage, and governance. Data Governance can include policies and processes to ensure data quality, security, privacy, and compliance with regulations. Data integration components can provide application programming interfaces (APIs), data virtualization, etc. The APIs can be used for accessing and integrating data across different systems. Data Virtualization techniques can be used for abstracting and integrating data from various sources without moving it physically. The data analytics components can have Business Intelligence (BI) and advanced analytics tools and platforms for data reporting, visualization, and dashboards to support decision-making. Advanced analytics techniques, like data mining, predictive analytics, and statistical analysis, can be used to derive deeper insights. The ML/AI platforms can provide a model training platform for developing and training machine learning models using data stored in the platform, and a model deployment platform for deploying trained models into production environments for real-time or batch inference. Data security components can provide access control, encryption, etc. Access control mechanisms can be used for ensuring that only authorized users can access specific data. Encryption techniques can be used for protecting data both at rest and in transit to prevent unauthorized access and breaches. The data management platform 150 can consolidate data from various sources into a single platform, making it easier to manage and access. The data management platform 150 can supports large-scale data storage and processing, accommodating growing data volumes and increasing complexity. The data management platform 150 can enable real-time data processing and analytics, allowing organizations to respond quickly to changing conditions. The data management platform 150 can facilitate collaboration across different departments and teams by providing a unified data environment. The data management platform 150 can implement data governance and quality control measures to ensure the accuracy and reliability of data. The data management platform 150 can provide organizations with the tools and insights needed to make informed, data-driven decisions. In summary, the data management platform 150 can provide the infrastructure and tools needed to manage, process, and analyze data effectively, enabling organizations to unlock the full potential of their data assets. The data management platform 150 can also provide business intelligence and reporting. The data management platform 150 can aggregate data from multiple sources to generate comprehensive reports and dashboards for business analysis. The data management platform 150 can provide real-time analytics. In particular, the data management platform 150 can monitor and analyze data streams in real-time to gain immediate insights and drive instant actions. The data management platform 150 can provide customer insights by analyzing customer data to understand behavior patterns, preferences, and trends to improve customer experience and loyalty. The data management platform 150 can implement predictive maintenance as well, such as using machine learning models to predict equipment failures and schedule proactive maintenance in industries like manufacturing and utilities.

As described herein, the data management platform 150 can be implemented in a cloud computing system, providing data storage, data warehousing, real-time data processing, analytic engines for large-scale data processing, ML/AI services, data flow for stream and batch processing, or other data services. As described in more detail below, the data management platform 150 can be executed by a computing system. The data management platform 150 can collect telemetry data from a plurality of different data sources in different network domains in a cellular network. The telemetry data can include FCAPS data, as described herein. The data management platform 150 can store the telemetry data in an object store associated with one or more sources associated with an application. The telemetry data can include first tier data and second tier data. The first tier data includes first data collected at an automation UE location, an edge location, or an end-node location, and has a first range of latency values. The first range of latency values can be microseconds up to a second in latency. The latency can include the amount of time to collect and/or additional time to aggregate or determine an insight locally about the collected data. The second tier data includes second data aggregated from the plurality of different data sources and has a second range of latency values, the second range having higher latency values than the first range. The second range of latency values can be a second up to tens of seconds. The latency can include the amount of time to collect and/or additional time to aggregate or determine an insight locally about the collected data.

In other embodiments, additional tiers of data can be defined and distinguished based on location, time, aggregation levels (i.e., granularity). The data management platform 150 can generate, using a crawler, a data catalog from the telemetry data stored in the object store by automatically discovering, indexing, and cataloging the first data and the second data from the plurality of different data sources in the different network domains. The data management platform 150 can receive a request from a subscriber service to provide visibility of at least the first tier data or the second tier data. It should be noted that the data management platform 150 isolates connections to the plurality of different data sources from the subscriber service. The data management platform 150 presents a GUI with real-time updates of geospatial information of the at least one of the first tier data or the second tier data in a singular comprehensive view. Additional details of the data management platform 150 are described below with respect to FIG. 3. FIG. 3 provides an overview of data processing activities in an SA ORAN environment.

In at least one embodiment, the data management platform 150 is executed by a computing system, such as a cloud computing system. In at least one embodiment, the object store resides in a private subnet of a virtual private cloud (VPC), the private subnet being associated with an account. In other embodiments, the data management platform 150 can be implemented in other locations associated with a cellular network.

According to embodiments, the data catalog 201 can use a crawler to automatically discover, index, and catalog the telemetry data. As described herein, the telemetry data can include FCAPS data. Alternatively, the telemetry data can include other data associated with the performance of devices and the cellular networks. The service catalog 202 can be used to deploy different copies or instances of the common data processing engine (e.g., data processing engine 303 of FIG. 3) at various network components or network functions. For example, the service catalog 202 can be used to deploy a first instance of the common data processing engine at a first event manager associated with a first data source in a first network domain in the cellular network. The first event manager can include a first data subscriber that outputs first FCAPS data to an object store associated with an account. The service catalog 202 can be used to deploy a second instance of the common data processing engine at a second event manager associated with a second data source in a second network domain in the cellular network, the second network domain being different than the first network domain. The second event manager can include a second data subscriber that outputs second FCAPS data to the object store associated with the account. Any function that processes data, collects data, or publishes data are recorded and monitored in the service catalog 202, whereas the results of the processing by the common data processing engine, for example, is data that is output to the data stores that are discovered, indexed, and made available via the data catalog 201 as described above. The data catalog 201 makes the data available for building KPIs and solutions that use these KPIs. The data catalog 201 and the service catalog 202 can be shared solutions that can be leveraged together to address the large amount of data generated in connection with the cellular network.

The data catalog 201 and the service catalog 202 allow management of data at various tiers of the data, providing visibility to all the data and allowing for correlations and reporting across all the various network domains. This management of data resolves the issues of the network in an end-to-end manner.

FIG. 3 is a block diagram of a document management platform 150 of a SA network providing connectivity between a network interface device (e.g., network interface device 105 of FIGS. 1 and 2) associated with one or more automation sub-systems (e.g., automation sub-system 101 of FIGS. 1 and 2) and one or more automation device control systems (e.g., automation device control system(s) 250 of FIG. 2), where the document management platform 150 manages a service catalog 202 with an example common data processing engine 303 according to at least one embodiment. The common data processing engine 303 includes a data collector 302, a data adaptor 304, an event streaming platform 306, a cloud-based storage unit 308, a data normalizer 310, a data aggregator 312, and a data standardizer 314. In at least one embodiment, the data collector 302 can collect one or more data logs 318 from a first data source. The data collector 302 can store the logs 318 in the cloud-based storage unit 308. The cloud-based storage unit 308 can be a storage unit in a storage service, such as the Amazon Web Services (AWS) Simple Storage Service (S3) bucket. The data adaptor 304 can receive data logs 318 (or just data) from the data collector 302 and generate one or more messages based on the one or more data logs. The one or more messages can be alarms 316, for example. The one or more messages can be topics, event data, or the like. The event streaming platform 306 can receive the one or more messages (alarms 316) from the data adaptor 304. The event streaming platform 306 can publish the one or more messages. The event streaming platform 306 can be, for example, an Apache Kafka bus. The data normalizer 310 can receive events from the event streaming platform 306 and/or access data logs 318 stored in the cloud-based storage unit 308. The data normalizer 310 can generate normalized data from the one or more data logs from the cloud-based storage unit 308 and the one or more messages from the event streaming platform 306. The data aggregator 312 can generate aggregated data from the normalized data. The data standardizer 314 can generate standardized data from the aggregated data. The FCAPS data, collected and processed by the common data processing engine 203, can include the standardized data output by the data standardizer 314. For example, the output of the particular instance of the common data processing engine 203 can store the standardized data, collected and processed, from the first data source in the object store described above. The data catalog 201 can automatically discover and index the normalized data for providing visibility into the normalized data.

In one example, a developer can be given a requirement to be able to ingest data from an event streaming platform 306 (e.g., Apache Kafka bus) and a cloud-based storage unit 308 (e.g., S3 bucket). Kafka is an open-source distributed event streaming platform developed by the Apache Software Foundation. It is designed for high-throughput, low-latency data streaming and is used to build real-time data pipelines and streaming applications. Kafka is capable of handling trillions of events per day and supports features such as message publishing and subscribing, fault tolerance, scalability, and distributed storage. It can be used for log aggregation, real-time analytics, and event sourcing. The S3 bucket is a fundamental storage unit that is used to store and manage data objects, which can include files, images, videos, and backups. Each bucket is uniquely identified by a key and can hold an unlimited amount of data. Features of S3 buckets include versioning, access controls, lifecycle policies for data archiving, and replication for data durability and availability.

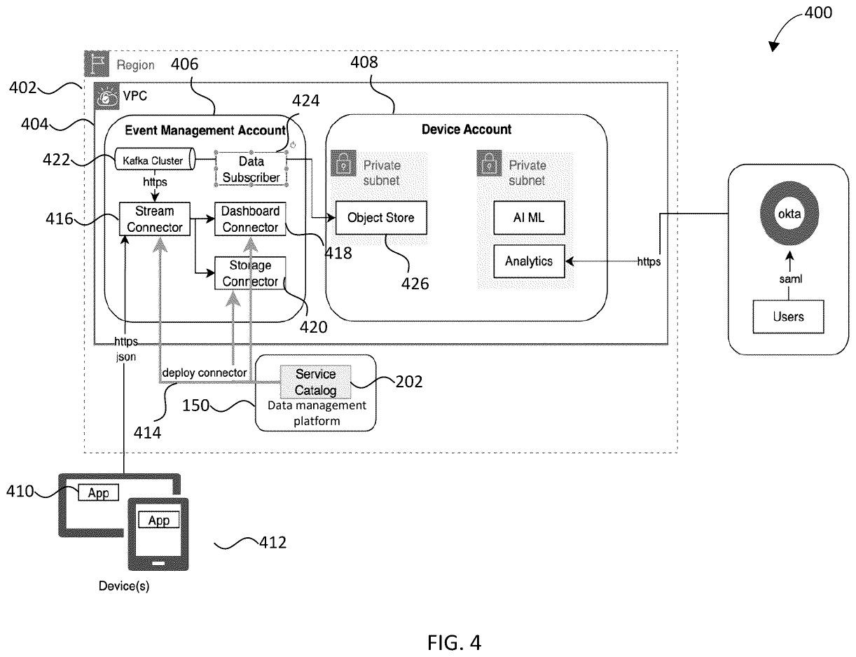

In another embodiment, the common data processing engine 303 includes a stream connector, a dashboard connector, a storage connector, and a deploy connector. The first instance can be deployed using a first instance of the deploy connector in the service catalog 202. The second instance can be deployed using a second instance of the deploy connector in the service catalog 202. An example of the service catalog 202 is illustrated and described below with respect to FIG. 4.

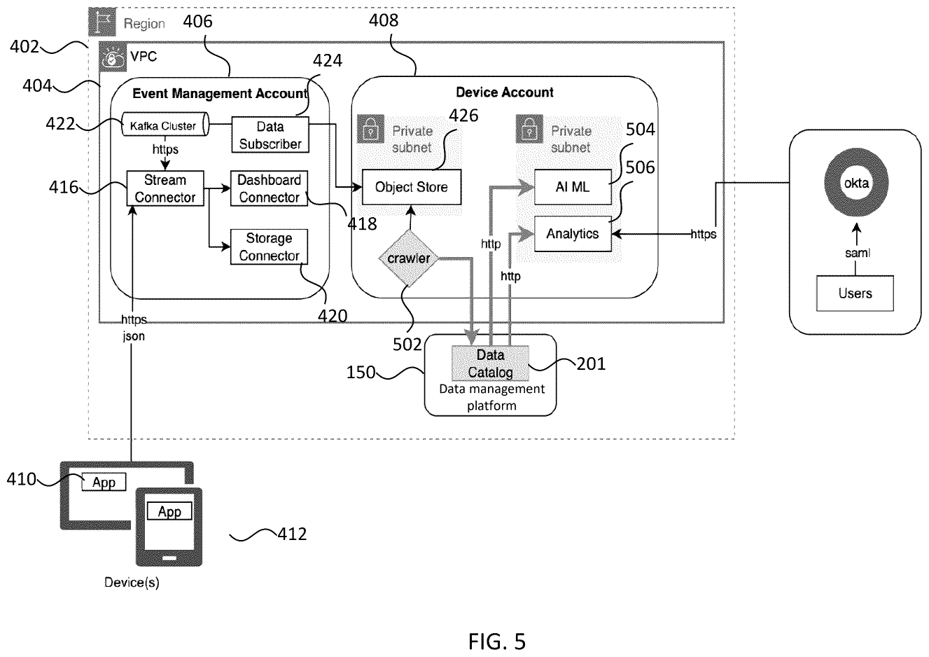

FIG. 4 is a block diagram of a data management platform 150 with a service catalog 202 being deployed in a region 402 of an SA network 400 according to at least one embodiment. A VPC 404 can be established in the region 402. Within the VPC 404 can be an event management account 406 and a device account 408. The data management platform 150 can be implemented in the VPC 404. The data management platform 150 can use the service catalog 202 to deploy a common data processing engine (e.g., 203) at the event management account 406 to collect data from a source application 410 of one or more device(s) 412 (e.g., controllable automation devices of automation sub-system 101 of FIGS. 1 and 2). In this embodiment, the service catalog 202 can use a deploy connector 414 to deploy a stream connector 416, a dashboard connector 418, and a storage connector 420 in the event management account 406. The event management account 406 can also include a Kafka cluster 422 and a data subscriber 424. The stream connector 416, dashboard connector 418, and storage connector 420 facilitate the collection and storage of the data from the source application 410 into an object store 426 associated with the device account 408. The object store 426 can be in a private subnet of the device account 408. The object store 426 can be separated from other private subnets in the device account 408, such as a private subnet with an AI/ML application, an analytics application, or other subscriber services. The service catalog 202 can be used to deploy the common data processing engine in the event management account 406 to collect the data from the source application 410 and store the data in the object store 426 associated with the device account 408. The service catalog 202, which resides in the region 402, can be used to deploy other instances of the common data processing engine in other event management accounts than the event management account 406, and/or for other device accounts than the device account 408. For example, the common data processing engine can include the stream connector 416, the dashboard connector 418, the storage connector 420, and the deploy connector 414, and a first instance can be deployed using a first instance of the deploy connector 414 in the service catalog 202. A second instance can be deployed using a second instance of the deploy connector 414 in the service catalog 202. As such, the service catalog 202 can be used to deploy the common data processing engine (or other data pipelines) in different locations in the cellular network 400. The deployment of the common data processing engine can facilitate the use of the data catalog 201 to provide the singular comprehensive view 204 of the collected data from various tiers and domains in the cellular network 400. An example of the data catalog 201 is illustrated and described below with respect to FIG. 5.

FIG. 5 is a block diagram of the data management platform 150 with the data catalog 201 being deployed in the region 402 of an SA network 400 according to at least one embodiment. As illustrated in FIG. 5, once the stream connector 416, the dashboard connector 418, and the storage connector 420 are deployed at the event management account 406, the data catalog 201 can collect the data published from the source application 410 on the one or more device(s) 412. In particular, the data catalog 201 can use a crawler 502 to automatically discover, index, and catalog the data in the object store 426, collected from the source application 410. The data catalog 201 can provide visibility to the data to one or more subscriber services, such as an AI/ML application 504, an analytics application 506, or the like. The AI/ML application 504 can use the data to determine one or more insights for other business logic associated with the device account 408. The analytics application 506 can use the data to determine one or more KPIs as described herein. The data catalog 201 can receive a request from one of the AI/ML application 504, analytics application 506 to provide visibility to the collected data (e.g., first tier data, second tier data, or both). The data catalog 201 can provide isolation between the AI/ML application 504 (or analytics application 506) and the source application 410. In response to the request, the data management platform 150 can provide the data to the AI/ML application 504 (or analytics application 506) to determine one or more insights of network performance irregularities or usage patterns associated with the device account 408 across the different network domains (or tiers) in the region 402 of the cellular network 400. The data management platform 150 (or AI/ML application 504 or analytics application 506) can determine the real-time updates of geospatial information based on the one or more insights. In response to the request, the data management platform 150 can present a GUI with real-time updates of geospatial information in a singular comprehensive view. As described herein, the singular comprehensive view 204 of the GUI can consolidate the one or more insights of network performance irregularities or usage patterns from the data sources into layers (e.g., tiers within the different network domains) within a unified platform, namely the data management platform 150.

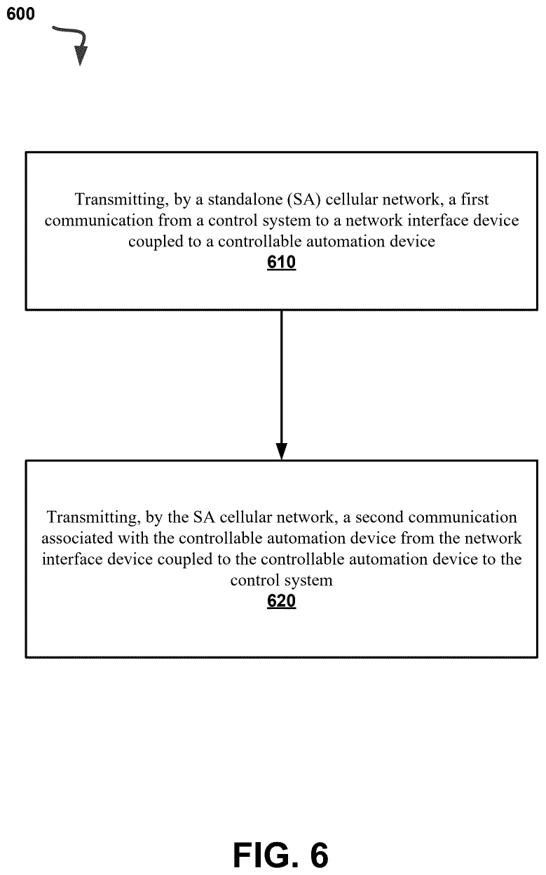

FIG. 6 is a flow chart of a method 600 of transmitting communications between a controllable automation UE and a control system using a current generation SA network, according to at least one embodiment. The method 600 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the method 600 is performed by network infrastructure components of the SA cellular network 120 of FIGS. 1 and 2. The method 600 can be performed by other computing systems described herein.

Referring to FIG. 6, at operation 610, a standalone (SA) cellular network transmits a first communication from a control system to a network interface device coupled to a controllable automation device. In an embodiment, the first data communication transmitted from the control system via the SA cellular network may be a command or instruction relating to the operation or functionality of the controllable automation device. According to embodiments, the control system may send the first data communication via the SA cellular network to the network interface device, which in turn transmits the first data communication to the controllable automation device. In an embodiment, the first data communication may be transmitted by the network interface device to another device (e.g., a DNP3 device, an Ethernet switch, a private access point name network device, etc.) within an automation sub-system (e.g., automation sub-system 101 of FIGS. 1 and 2), which in turn transmits the first data communication to the target controllable automation device.

At operation 620, the SA cellular network transmits a second communication associated with the controllable automation device received from the network interface device coupled to the controllable automation device to the control system. In an embodiment, the second data communication is received by the network interface device from the controllable automation device, and enables transmission via the SA cellular network to the control system. In an embodiment, the second data communication may be related to the first data communication. For example, the second data communication may be provide a confirmation or feedback relating to the control command executed by the controllable automation device in response to the first data communication. For example, the first data communication can include a command indicating that the controllable automation device is to perform Operation ABC. In this example, the second data communication can include a confirmation that the controllable automation device successfully performed Operation ABC.

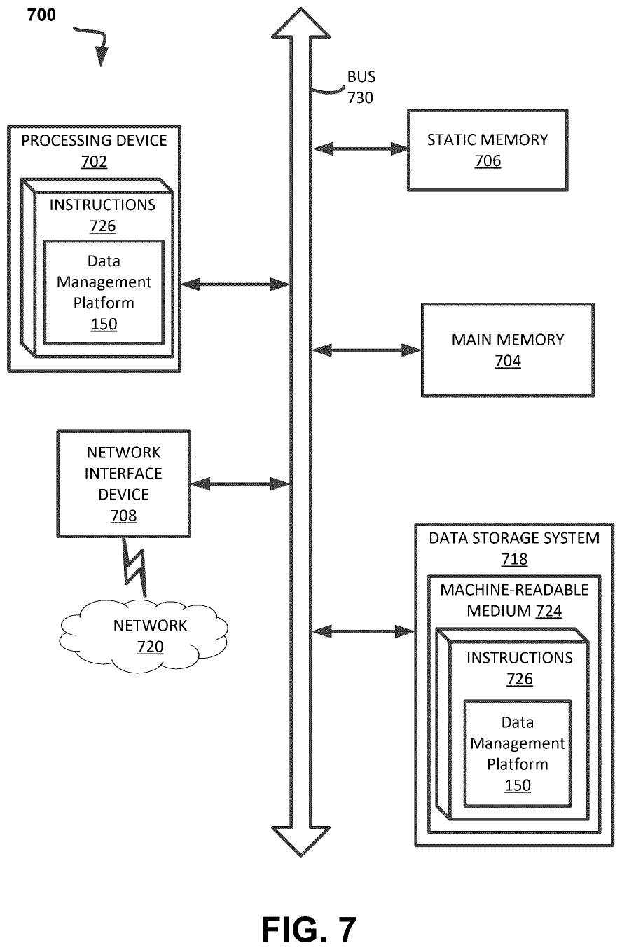

FIG. 7 is a block diagram of an example environment 700 for providing a data management platform with a GUI for creating or modifying graphical objects representing underlying executable code for functions of a cellular network according to at least one embodiment. The example environment 700 includes a computing system 702 including one or more computing devices, a network 704, one or more data sources 714, and a user device 716.

The one or more data sources 714 can be located in different sites either on the same network or entirely different networks. Each data source 714 can have its own data included in data files. The data of each data sources 706 can include structured data, unstructured data, or both. Structured data refers to data that is organized in a specific format or structure, making it easy to search, process, and analyze using automated tools. This data is typically stored in databases, spreadsheets, or other data management systems. Structured data is characterized by the presence of clearly defined fields, columns, and rows, and often follows a consistent format or syntax. Examples of structured data include financial data, inventory data, customer information, and transactional data. Unstructured data refers to data that is not organized in a specific format or structure, making it difficult to process and analyze using automated tools. This data is often created in a free-form manner and does not follow a consistent syntax. For example, unstructured data is a conglomeration of many varied types of data that are stored in their native formats, which can result in irregularities and ambiguities that make it difficult to understand as compared to structured. Examples of unstructured data can include emails, social media posts, audio and video recordings, images, and text documents. Unstructured data is more difficult to analyze and interpret than structured data because it requires natural language processing and other advanced techniques to extract insights and meaning. However, unstructured data can provide valuable insights into customer sentiment, market trends, and other areas that are not easily captured by structured data.

Each data source 714 can have one or more data dictionaries describing its data files. The data dictionary can include information or metadata about data of the data files such as attributes, meaning, origin, usage, and format of the data included in the data files. For example, the metadata associated with the data files can include a plurality of features of the data included in the data files. The plurality of features can include at least one of: a file name, a table name, an attribute, a row name, and a column name. One of the features can be an attribute indicating whether a corresponding data file includes unstructured data.

The data dictionaries of the data sources 714 can be used to create a graph database representing metadata of the data files from one or more data sources 714. Specifically, relationships among the plurality of features of different data files can be determined using the data files'data dictionaries. For example, a relationship can be two data files sharing the same attribute. A graph database can be created to reflect the features and the relationships of the features for different data files. The graph database can be represented as a directed graph that includes a set of nodes and a set of edges. Each node can represent a feature of the plurality of features. Each edge can represent a relationship between two nodes in the set of nodes (e.g., relationships among the plurality of features of the data files). As a result, the graph database can include the relationships (e.g., interconnections and interrelationships) of the data files from various data sources with respect to the features of the data files.

In some implementations, the graph database can be generated by the computing system 702 in advance based on the data dictionaries received from the data sources 714. In some implementations, the graph database can be generated by another computing system (not shown). The computing system 702 can access the graph database from that computing system over the network.

The computing system 702 can traverse the graph database to identify unstructured data included in one or more data files from the data sources 714. The computing system 702 can further identify, from the graph database, the data sources 714 of data files that include unstructured data. For example, in a graph database, the data source 714 of each data file can be a represented as a node connected to another node representing the data file. In some implementations, the graph database can include a feature that indicates storage locations of particular data files. The computing system 702 can obtain the unstructured data, based on the storage location of the unstructured data, from the data source 714 and run assessment code on the computing system 702 to check the data quality of the unstructured data. In some implementations, the computing system 702 can provide the assessment code to the data source 714, so that the assessment code can be run at the data source 714.

The assessment code can check whether the unstructured data of the data files satisfies a set of rules. The set of rules can include customized rules that are specific to the use case of the unstructured data. For example, if the unstructured data is a log for user interactions with different applications, the customized rules can include rules to check whether the user's account includes a valid email address, but not whether the user provides a valid physical address. In another example, if the unstructured data includes online shopping orders, the customized rules include rules to check whether the shipping address is a valid physical address, and whether the shipping address is consistent with the postal code. In some implementations, the computing system can use machine learning models to determine the general rules and the customized rules for the unstructured data.

The computing system 702 can generate a data quality report for the unstructured data including i) the data quality results for the unstructured data in each data file and ii) recommendations of potential modifications for rectifying unstructured data not satisfying one or more rules included in the set of rules. The data quality report can be displayed on a user device 716. The user device 716 can be associated with a developer that utilizes the unstructured date and develops data products, artificial intelligence (AI)/machine learning (ML) algorithms, and dashboards. In some implementations, the data quality report can be provided to a user device 716 associated with a data owner of the unstructured data or an administrative user managing the unstructured data.

The computing system 702 can further provide the potential modifications to the unstructured data as a recommendation to the user device 716, so that the user of the user device 716 can determine whether to adopt that modification. In response to receiving the user's confirming to rectify the unstructured data not satisfying the one or more rules, the computing system 702 can proceed to make the modification. The computing system 702 can trigger rectifying code to make the modifications.

In some implementations, the computing system 702 can obtain the unstructured data, based on the storage location of the unstructured data, from the data source 714 and run the rectifying code on the computing system 702. In some implementations, the computing system 702 can provide the rectifying code to the data source 714, so that the rectifying code can be run at the data source 714.

The computing system 702 can include one or more computing devices, such as a server. The number of computing devices may be scaled (e.g., increased or decreased) automatically as per the computation resources needed. The various functional components of the computing system 702 may be installed on one or more computers as separate functional components or as different modules of a same functional component. For example, the various components of the computing system 702 can be implemented as computer programs installed on one or more computers in one or more locations that are coupled to each through a network. In cloud-based systems for example, these components can be implemented by individual computing nodes of a distributed computing system.

The user device 716 can include personal computer, mobile communication device, and other devices that can communicate with the computing system 702 over the network 704. The network 704 can include a local area network (“LAN”), wide area network (“WAN”), the Internet, or a combination thereof. Each data source 714 can include one or more computing devices, such as a server. Each data source 714 can have its own database that stores its data files and corresponding data dictionaries.

Embodiments of the subject matter and the actions and operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions, encoded on a computer program carrier, for execution by, or to control the operation of, data processing apparatus. The carrier may be a tangible non-transitory computer storage medium. Alternatively or in addition, the carrier may be an artificially-generated propagated signal, e.g., a machine-generated electrical, optical, or electromagnetic signal, that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal. A non-transitory computer-readable storage medium can include instructions that when executed by a computing system, cause the computing system to perform operations as described herein.

The term “data processing apparatus” encompasses all kinds of apparatus, devices, and machines for processing data, including by way of example a programmable processor, a computer, or multiple processors or computers. Data processing apparatus can include special-purpose logic circuitry, e.g., an FPGA (field programmable gate array), an ASIC (application-specific integrated circuit), or a GPU (graphics processing unit). The apparatus can also include, in addition to hardware, code that creates an execution environment for computer programs, e.g., code that constitutes processor firmware, a protocol stack, a database management system, an operating system, or a combination of one or more of them.

A computer program can be written in any form of programming language, including compiled or interpreted languages, or declarative or procedural languages; and it can be deployed on a system of one or more computers in any form, including as a stand-alone program, e.g., as an app, or as a module, component, engine, subroutine, or other unit suitable for executing in a computing environment, which environment may include one or more computers interconnected by a data communication network in one or more locations.

A computer program may, but need not, correspond to a file in a file system. A computer program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

The processes and logic flows described in this specification can be performed by one or more computers executing one or more computer programs to perform operations by operating on input data and generating output. The processes and logic flows can also be performed by special-purpose logic circuitry, e.g., an FPGA, an ASIC, or a GPU, or by a combination of special-purpose logic circuitry and one or more programmed computers.

Computers suitable for the execution of a computer program can be based on general or special-purpose microprocessors or both, or any other kind of central processing unit. Generally, a central processing unit will receive instructions and data from a read-only memory or a random access memory or both. The essential elements of a computer are a central processing unit for executing instructions and one or more memory devices for storing instructions and data. The central processing unit and the memory can be supplemented by, or incorporated in, special-purpose logic circuitry.

Generally, a computer will also include, or be operatively coupled to, one or more mass storage devices, and be configured to receive data from or transfer data to the mass storage devices. The mass storage devices can be, for example, magnetic, magneto-optical, or optical disks, or solid state drives. However, a computer need not have such devices.

Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, embodiments of the subject matter described in this specification can be implemented on one or more computers having, or configured to communicate with, a display device, e.g., a LCD (liquid crystal display) or organic light-emitting diode (OLED) monitor, a virtual-reality (VR) or augmented-reality (AR) display, for displaying information to the user, and an input device by which the user can provide input to the computer, e.g., a keyboard and a pointing device, e.g., a mouse, a trackball or touchpad. Other kinds of devices can be used to provide for interaction with a user as well; for example, feedback and responses provided to the user can be any form of sensory feedback, e.g., visual, auditory, speech or tactile; and input from the user can be received in any form, including acoustic, speech, or tactile input, including touch motion or gestures, or kinetic motion or gestures or orientation motion or gestures. In addition, a computer can interact with a user by sending documents to and receiving documents from a device that is used by the user; for example, by sending web pages to a web browser on a user's device in response to requests received from the web browser, or by interacting with an app running on a user device, e.g., a smartphone or electronic tablet. Also, a computer can interact with a user by sending text messages or other forms of message to a personal device, e.g., a smartphone that is running a messaging application, and receiving responsive messages from the user in return.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform the operations or actions. That one or more computer programs is configured to perform particular operations or actions means that the one or more programs include instructions that, when executed by data processing apparatus, cause the apparatus to perform the operations or actions. That special-purpose logic circuitry is configured to perform particular operations or actions means that the circuitry has electronic logic that performs the operations or actions.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of what is being claimed, which is defined by the claims themselves, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially be claimed as such, one or more features from a claimed combination can in some cases be excised from the combination, and the claim may be directed to a sub-combination or variation of a sub-combination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A system comprising:
an automation sub-system comprising one or more controllable automation devices; and
a network interface device coupled to the automation sub-system to enable data communication between the one or more controllable automation devices and a base station providing access to a standalone (SA) cellular network.

2. The system of claim 1, further comprising a distributed network protocol (DNP3) device enabling communication between the network interface device and the one or more controllable automation devices of the automation sub-system.

3. The system of claim 1, further comprising an Ethernet switch enabling communication between the network interface device and the one or more controllable automation devices of the automation sub-system.

4. The system of claim 1, further comprising a private access point name network device enabling communication between two or more automation devices of the automation sub-system.

5. The system of claim 1, further comprising one or more mobile computing devices, wherein the one or more mobile computing devices are coupled to the SA cellular network via the network interface device.

6. The system of claim 1, wherein the SA cellular network comprises one of a fifth generation (5G) SA open radio access network (ORAN) or a sixth generation (6G) SA ORAN.

7. The system of claim 1, wherein the SA cellular network transmits one or more control communications from a control system to the one or more controllable automation devices.

8. A method comprising:
transmitting, by a processing device of a standalone (SA) cellular network, a first data communication from a control system to a network interface device coupled to a controllable automation device; and
transmitting, by the processing device of the SA cellular network, a second data communication associated with the controllable automation device from the network interface device coupled to the controllable automation device to the control system.

9. The method of claim 8, wherein the control system is located at a first location; and
wherein the network interface device and the controllable automation device are located at a second location.

10. The method of claim 9, wherein the network interface device is coupled to a distributed network protocol (DNP3) device located at the second location; and wherein the DNP3 device enables communication between the network interface device and the controllable automation device.

11. The method of claim 9, wherein the network interface device is coupled to an Ethernet switch located at the second location; and wherein the Ethernet switch enables communication between the network interface device and the controllable automation device.

12. The method of claim 9, wherein the network interface device is coupled to a private access point name network located at the second location; and wherein the private access point name network enables communication between the controllable automation device and one or more additional controllable automation devices located at the second location.

13. The method of claim 12, wherein the SA cellular network enables a private network associated with the controllable automation device and the one or more additional controllable automation devices.

14. The method of claim 13, wherein the SA cellular network employs enhanced Mobile Broadband slicing associated with the private network.

15. A system comprising:
a fifth generation (5G) standalone (SA) open radio access network (ORAN) comprising one or more base stations; and
a network interface device coupled to a set of controllable automation devices to enable access to the one or more base stations of the 5G SA ORAN.

16. The system of claim 15, wherein the 5G SA ORAN transmits a first communication from a communicatively coupled control system to the set of controllable automation devices via the network interface device.

17. The system of claim 16, wherein the first communication causes execution of an operation by a first controllable automation device of the set of controllable automation devices.

18. The system of claim 16, wherein the control system is located at a first location and the set of controllable automation devices are located at a second location.

19. The system of claim 15, wherein the 5G SA ORAN generates a private network associated with a first controllable automation device of the set of controllable automation devices and a second controllable automation device of the set of controllable automation devices.

20. The system of claim 19, wherein the 5G SA ORAN employs enhanced Mobile Broadband slicing associated with the private network.
